(19) United States
(12) Patent Application Publication
(10) Pub. No.: US 2015/0140872 A1
(43) Pub. Date: May 21, 2015

(54) Battery Cable Connector with Open Back Handle

(71) Applicants: Charles M. Orange, Nashville, TN (US); Steven A. Eller, Nashville, TN (US)

(72) Inventors: Charles M. Orange, Nashville, TN (US); Steven A. Eller, Nashville, TN (US)

(21) Appl. No.: 14/550,142

(22) Filed: Nov. 21, 2014

Related U.S. Application Data
(60) Provisional application No. 61/907,174, filed on Nov. 21, 2013.

(51) Int. Cl. H01R 4/38

(52) U.S. Cl. CPC H01R 4/38
USPC 439/762

(57) ABSTRACT

An improved battery cable clamp is provided with an integral T shaped connecting rod mounted in the handle of the clamp.

### FIELD OF THE INVENTION

The present invention relates to an improved battery cable connector of the type utilizing a boss rotating against a cam seat to effect a quick clamping or releasing action.

### BACKGROUND OF THE INVENTION

It is well known that most automobiles and motor vehicles, inboard boats, some outboard boats, and many recreational and commercial vehicles are started by battery power. The standardized modern battery is a 12 volt battery having metal posts for the opposing polarities of the battery to which connector cables are attached. Typically the battery cable is connected to one end of a connector and a yoke portion of the connector is fitted over the battery post and clamped down onto the battery post by tightening a nut onto a bolt passing through the two ends of the yoke. Other battery cables are fitted with conductive eyelets at the end and those eyelets are bolted directly to battery terminals having apertures, as in the case of lawn and garden batteries, or to side terminals adapted to receive bolts in the case of side terminal batteries.

Many batteries will last for several years and when the batteries are finally spent, the old battery must be removed and replaced with a new one. Under these circumstances, the battery cable clamp must be loosened and often corrosion must be broken to remove the clamp from the post. Similarly, in some cases, corrosion may build up in the junction between the battery clamp and the battery post and impair proper transmission of battery power from the battery post through the connector to the battery cable and diminish the electrical power available. A variety of quick clamping designs have been proposed to address the corrosion issues including those depicted in U.S. Pat. Nos. 6,802,747; No. 7,029,338, and No. 7,189,123, each of which is incorporated herein by reference. In each of these prior art designs, a pin is mounted in a cammed handle, a connecting rod is affixed to the pin, a cam seat is placed over the connecting rod, and the connecting rod is then used as a bolt to either fit into a side terminal or to be passed through an aperture and fastened to a threaded nut. In practice, these battery cable clamps provide good functionality, however, they are difficult to manufacture at optimal cost. In particular, the assembly of the clamp by placing the pin in the openings in the wings of the handle then applying thread lock material to one threaded end of the connecting rod and then fastening the connecting rod into an opening within the pin is labor intensive. It is also expensive to machine the metal parts comprising the pin and the connecting rod. Furthermore, unless skilled and attentive labor is utilized, connecting rods may be fastened within the opening of the pin at different lengths. The preferred metals for these components have also resulted in the thread lock being inadequate to hold through periods of rigorous use in a significant percentage of the cases. This thread lock failure sometimes is attributable to the failure to completely remove the machine oil used in fashioning the metal parts before their assembly. An additional expense in the prior art clamps is that the end cap must be fitted with an internal metal threaded section in order to have sufficient strength to hold its position on the connecting rod when the clamp is tightened by rotating the cammed boss on the cam seat.

What is needed then is a battery cable clamp that can be manufactured in a more uniform fashion at less expense than the prior art devises.

### SUMMARY OF THE INVENTION

Instead of a two part pin and connecting rod assembly, a unitary pin and connecting rod is cast resulting in an integral T-shaped component. Instead of inserting a pin through openings in the wings, the wings may be formed without openings and the T-shaped pin and connecting rod may be introduced through a window in the handle opposite of a slot through which the connecting rod is passed. Because the connecting rod and pin are formed as a single piece, there is no labor required to assemble the two parts, no issues with obtaining uniform threadlock between the parts, and no issues of different length connecting rods due to variations in the tightening of fastening rods within the opening of the prior art pins. Furthermore, because the pin and connecting rod are cast, the threads on the connecting rod may be cast as Acme threads or square threads and the plastic end nut can be cast with the corresponding square mating threads. These Acme threads provide relatively greater strength than tapered threads and accordingly it may not be necessary to utilize a metal insert within the nut. Additional modifications may include building a cam seat into a nonlead style yoke so that the cam seat element is not required as a part of the battery cable clamp assembly. When using nonlead yokes a heel may be formed at the open end of the yoke, or included on the cam seat of battery cable clamp, to provide better connection between the yoke and battery terminal posts when the battery cable clamp is tightened, and an insulated boot may be included as a part of the battery cable clamp assembly.

### BRIEF DESCRIPTION OF THE DRAWINGS

The invention may be better understood with reference to the following drawings in which the numerals designate like parts and wherein:

FIG. 1 is an exploded perspective view of an exemplary clamp according to the invention.

FIG. 2A is a perspective view of an integral T-shaped connecting rod;

FIG. 2B is a distal end view of the T-shaped connecting rod of FIG. 2A.

FIG. 2C is a top plan view of the T-shaped connecting rod of FIG. 2A.

FIG. 2D is a side plan view of the T-shaped connecting rod of FIG. 2A.

FIG. 3A is a perspective view of an exemplary cam seat with heel section according to an embodiment of the invention.

FIG. 3B is a side plan view of the cam seat of FIG. 3A.

FIG. 3C is a top plan view of the cam seat of FIG. 3A.

FIG. 3D is a front sectional view of the cam seat of FIG. 3A.

FIG. 4A depicts a perspective view, and reverse angle perspective view of an exemplary handle according to an embodiment of the invention.

FIG. 4B is a distal end view of the handle of FIG. 4A.

FIG. 4C is a sectional view of the handle taken along the line B-B.

FIG. 4D is a top plan view of the handle of FIG. 4A.

FIG. 4E is an enlarged sectional view of the base of the handle within Circle C of FIG. 4C.

FIG. 5A is a perspective view and reverse angle perspective view of an insulating boot adapted to be used with a handle of the type shown in FIG. 4A.

FIG. 5B is a side plan view of the insulating boot of FIG. 5A.

FIG. 5C is a back plan view of the insulating boot of FIG. 5A.

FIG. 5D is a top plan view of the cover of FIG. 5A.

FIG. 5E is a top sectional view taken along line A-A in FIG. 5B.

FIG. 5F is an end sectional view taken along line B-B in FIG. 5B.

FIG. 6A is an enlarged distal end view of an end nut adapted for use with a connecting rod at the type shown in FIG. 2A.

FIG. 6B is a perspective view of the end nut of FIG. 6A.

FIG. 6C is an enlarged sectional view of the end nut of FIG. 6A taken along line A-A.

FIG. 7A is a perspective view of a cover to be used with a handle of the type shown in FIG. 4A.

FIG. 7B is a side plan view of the cover of FIG. 7A.

FIG. 7C is an end plan view of the cover of FIG. 7A.

FIG. 10A is a perspective view of a nonlead yoke connector of the type having a crimping ring.

FIG. 10B is a top plan view of the yoke connector of FIG. 10A.

FIG. 11A is a perspective view of a nonlead yoke connector of the type having a mounting plate.

FIG. 11B is a top plan view of the yoke connector of FIG. 11A.

FIG. 12A is a perspective view of a nonlead yoke connector of the type having a tabbed channel and heel.

FIG. 12B is a top plan view of the yoke connector of FIG. 12A.

FIG. 13A is a perspective view of the clamp of FIG. 1 as assembled for clamping by rotating the boss of the handle.

FIG. 13B is a perspective view of the clamp of FIG. 13A with the handle and insulating boot rotated approximately half-way to the clamped position.

FIG. 13C is a perspective view of the clamp of FIG. 13A with the handle and boot rotated to the clamped position.

FIG. 14 is an exploded perspective view of an exemplary clamp according to the invention designed to fasten to an L post terminal as might be found on a lawn and garden battery.

FIG. 15 is an exploded perspective view of an exemplary clamp according to the invention adapt to fasten on an L post without an insulating boot.

FIG. 16 is an exploded perspective view of an exemplary clamp according to the invention for use in a lead yoke style connector.

### DETAILED DESCRIPTION OF THE INVENTION

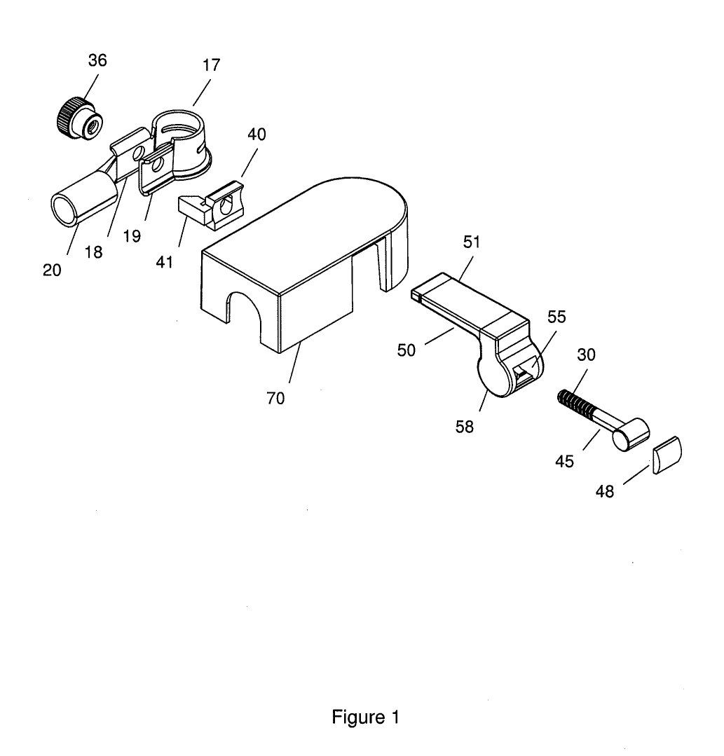

A description of preferred embodiments of the present invention will be best understood by referring to FIGS. 1-16 of the accompanying drawings where like reference numerals refer to like parts.

Turning then to FIG. 1, an exploded view of an insulated quick release clamp can be seen where the battery yoke 17 is designed to encompass an outstanding battery terminal while the pin 45 has a threaded end 30 that extends into opening 55 to extend through handle 50 and through the seat 40 and the legs 19, 18 of yoke 17 so that the threaded end 30 is received within end nut 36 and finger tightened. Then the handle 50 can be rotated so that boss 58 is interposed and tightens the clamp assembly and yoke 17 about the terminal. Each of the components may then be examined in greater detail.

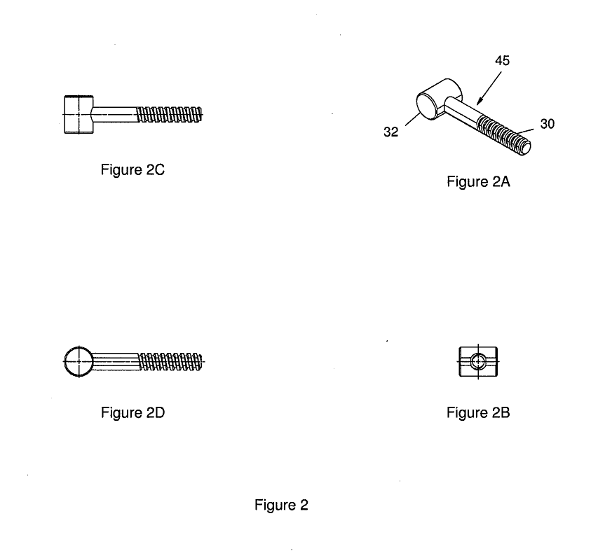

FIG. 2A reflects a perspective view of T-shaped pin 45. One end of pin 45 is threaded 30 while the other end is a cylindrical head 32 that is received and remains within the opening 55 of handle 50. The threads on end 30 are preferably square or acme threads to provide improved griping with matching threads in the end nut 36. When manufactured, T-shaped pin 45 is preferably cast of a zinc alloy that can be inexpensively made in large quantities.

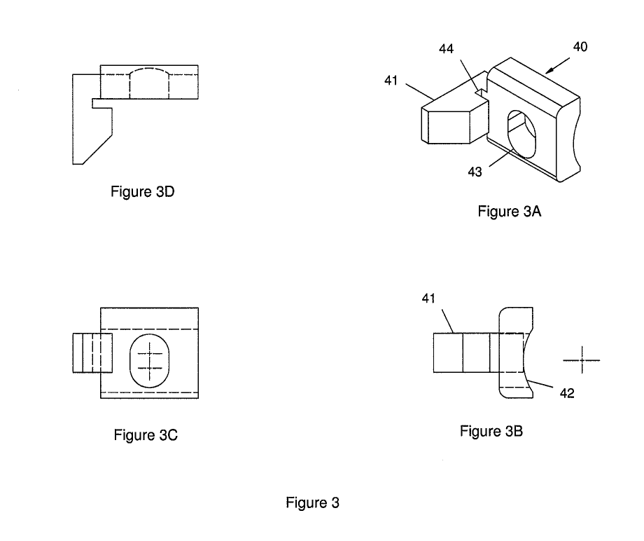

Turning then to FIG. 3A, a perspective view of the seat 40 with heel 41 is shown. The seat has an opening 43 through which the threaded end 30 of T-shaped pin 45 can pass and a curved surface 42 to facilitate rotation of the bossed section 58 of handle 50. The heel 41 is optional, but as shown in FIG. 1, heel 41 may be placed between the legs 18, 19 of yoke 17 with the notch 44 retaining open leg 19 and the body of the heel 41 serving to prevent the ends of legs 18, 19 from being that close together. Such bending is not desirable because it distorts the circular form of yoke 17 about the terminal causing gaping between the terminal and the yoke and thereby reducing conductivity between the two. The heel 41 forces the pressure applied by the clamp to be applied at the ends of the legs 18, 19 proximate to the yoke 17 so that the yoke 17 is securely fastened about the terminal.

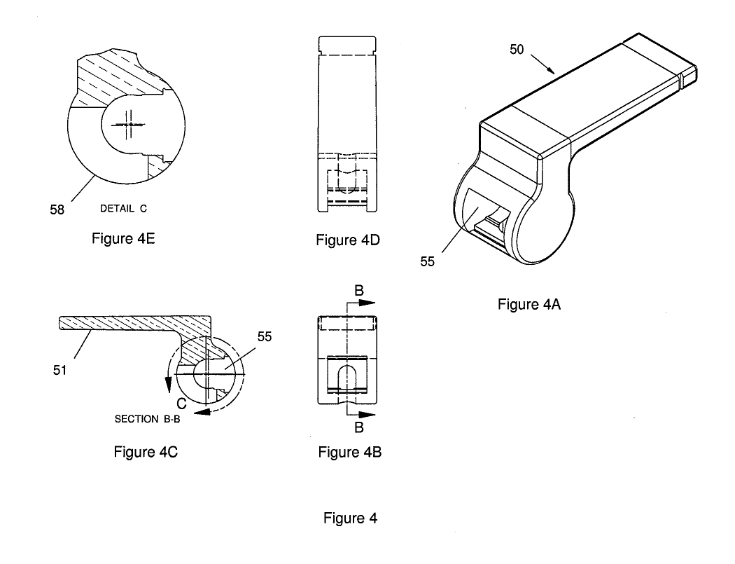

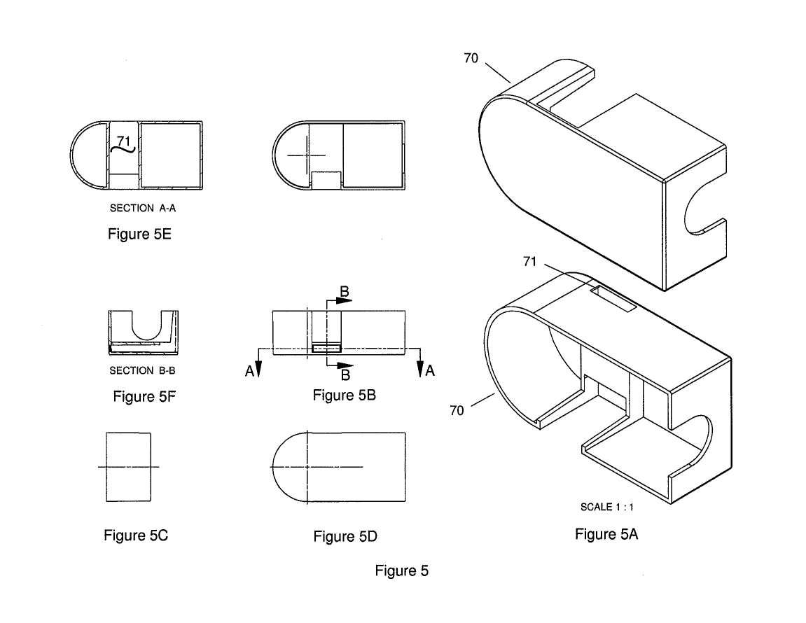

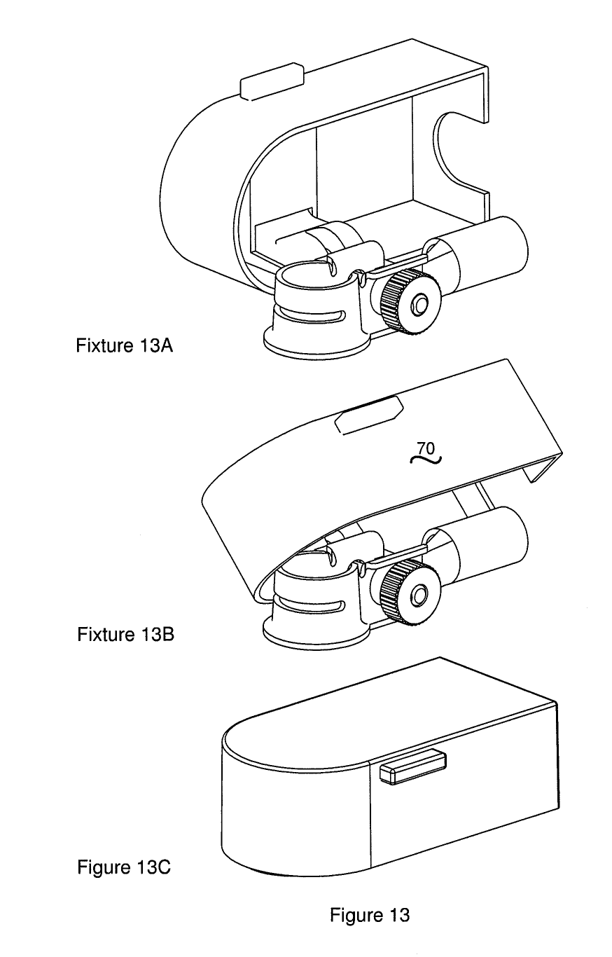

Turning then to FIG. 4A, the handle 50 is shown in isolation and it can be seen that handle 50 has an opening 55 in its rear and a forward facing slot on the opposite side approximately bossed section 58. This enables the cylindrical end 32 of the T-shaped pin 45 to rest within the handle while the handle can rotate about the pin to position the boss 58 to tighten or loosen the clamp. As shown in FIGS. 5A through F, an insulated boot 70 is provided with a slot 71 to receive the distal end 51 of handle 50. In this fashion, the insulated boot 70 rotates as the handle is placed into clamping or loosening position to cover or expose the battery terminal respectively, as shown in FIG. 13A-C.

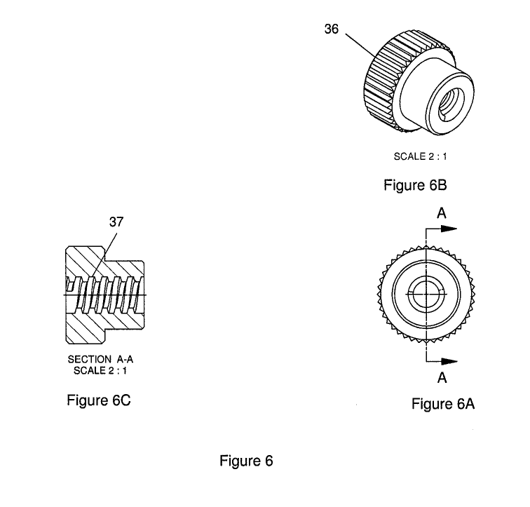

FIGS. 6A-C illustrate the end nut 36 and particularly threaded aperture 37 that is preferably made fitted with square or acme threads. Alternatively, the end nut may be fitted with a metal insert to provide the necessary strength to support clamping action. Preferably, the surface of nut 36 is knurled to facilitate grasping and turning.

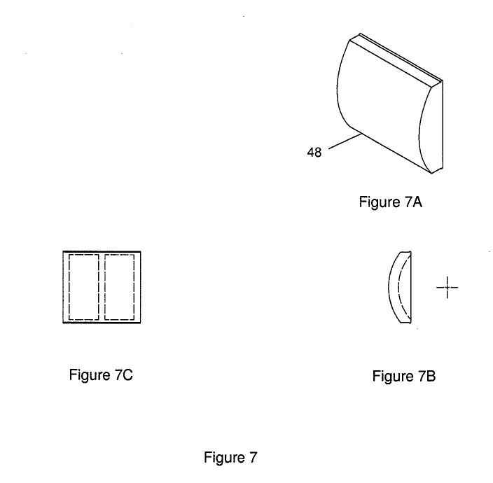

FIGS. 7A and B illustrate the handle cover 48 that covers opening 55 after T-shaped pin 45 has been inserted. This optional piece is provided for aesthetic reasons.

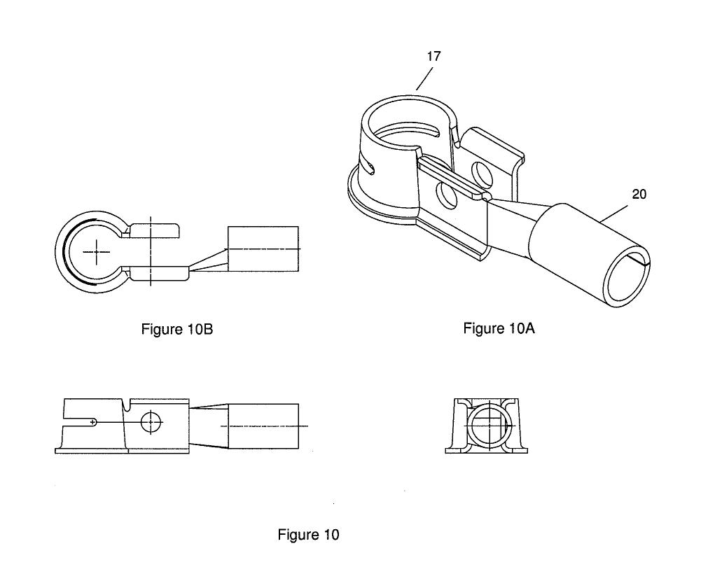

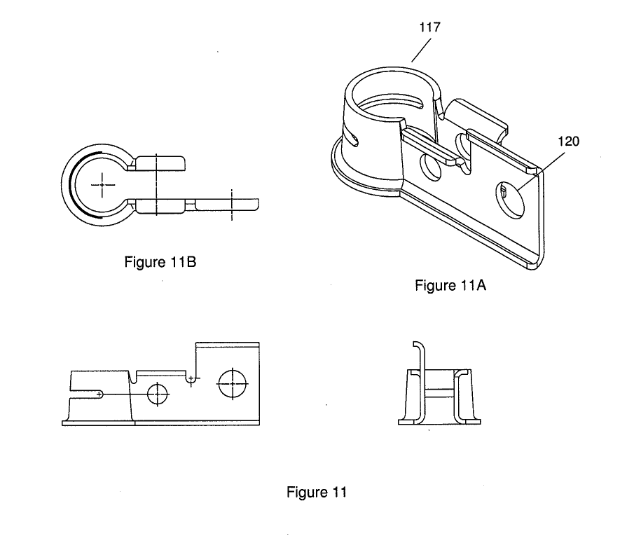

FIG. 10A illustrates a yoke connecter 17 having a crimping ring 20 for use in fastening to a battery cable. FIG. 11A illustrates a yoke 117 having a mounting plate 120 to which a battery cable having an eyelet end connector may be bolted.

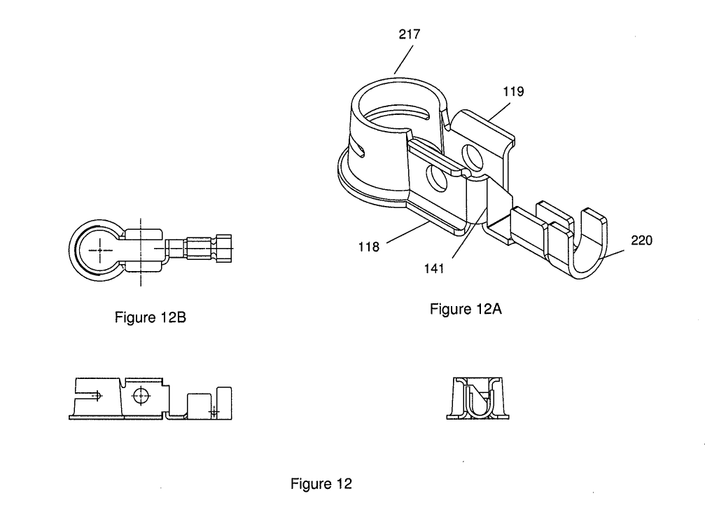

FIGS. 12A and B illustrate a yoke 217 having a tabbed open channel connector 220 in which a cable is placed and tabs folded to clamp the cable in position. In addition, this yoke 217 has an integral heel 141 that prevents the clamping of the sections of legs 118, 119 distal from the yoke portion which would otherwise distort the fit of the yoke's about the terminal post.

FIGS. 13A-C show the movement of handle 50 from the unbossed (FIG. 13A) into the bossed position (FIG. 13C) thereby tightly clamping the battery clamp about the terminal post while simultaneously closing the insulating boot 70 over the terminal and clamp apparatus to protect the connection from the elements and corrosion, and to prevent invertent short circuits and sparks.

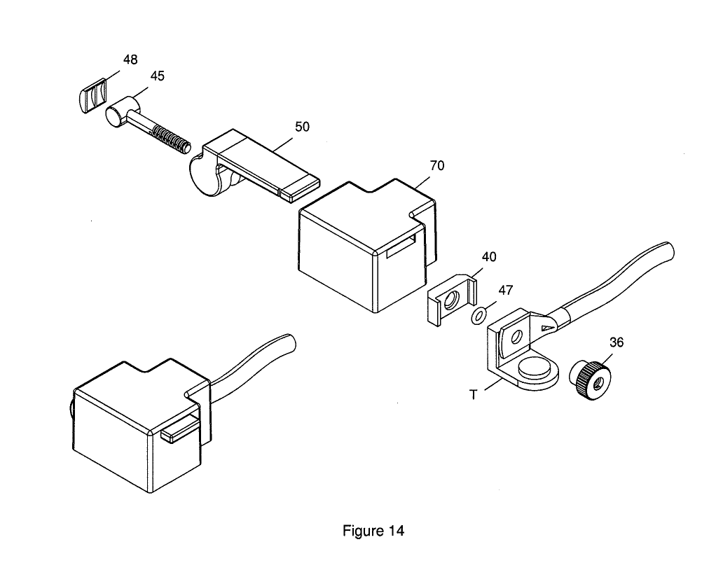

FIG. 14 is an exploded perspective view of a clamp having T shaped pin 45 received within handle 50 that engages with boot 70. Pin 45 proceeds through seat 40 over 47 and through terminal T and end cap 36 is finger tightened onto the pin. This is a typical terminal configuration for a lawn and garden battery clamp. A very similar clamp could be used within an end camp 36 to fasten a battery cable to a side terminal.

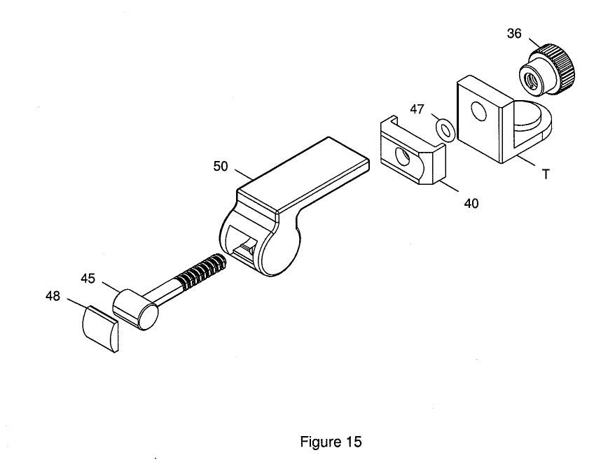

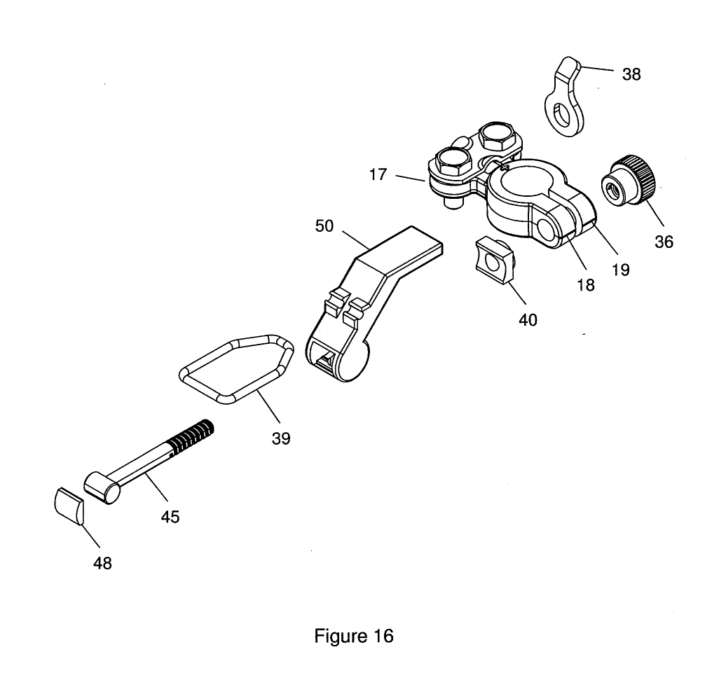

FIG. 15 is an exploded view of the clamp of FIG. 14 without the insulating hood 70. FIG. 16 is an exploded perspective view of battery clamp with handle 50 having a unitary pin 45 received through the handle to engage across the legs 18, 19 of yoke 17. The oblong ring 39 engages with the number 38 to provide leverage to break any rust or corrosion that might bind the clamp or cable to the battery post.

All publications, patent, and patent documents mentioned herein are incorporated by reference herein as though individually incorporated by reference. Although preferred embodiments of the present invention have been disclosed in detail herein, it will be understood that various substitutions and modifications may be made to the disclosed embodiment described herein without departing from the scope and spirit of the present invention as recited in the appended claims.

We claim:

1. An improved battery cable clamp with T pin connector substantially as shown and described.
